(19) United States
(12) Patent Application Publication
(10) Pub. No.: US 2004/0173447 A1
(43) Pub. Date: Sep. 9, 2004

(54) Membrane switch and its application to acoustic strip wallpaper and picture board

(76) Inventor: Young-Woo Lee, Seoul (KR)

Correspondence Address: Peter T. Kwon, G W i P S, Kangnam, P.O. Box 2301, Seoul, 135-242, KR

(21) Appl. No.: 10/669,455

(22) Filed: Sep. 25, 2003

(30) Foreign Application Priority Data
Mar. 4, 2003 (KR) 2003-0006321
Jul. 3, 2003 (KR) 2003-0021358
Jul. 14, 2003 (KR) 2003-0022620

(51) Int. Cl. H01H 1/10

(52) U.S. Cl. 200/512

(57) ABSTRACT

A membrane switch comprises a first conductor (1) for electrically coupling the positive terminal of a power battery (33), a second conductor (2) for electrically coupling the negative terminal of the power battery (33), a set of paired, inter-digital shaped electrodes (3a, 3b) having a plurality of insulation bump dots (P) arranged in certain intervals, a first connector (4) with one end connected to the first conductor (1) and the other end connected to one of the paired, inter-digital shaped electrode (3a), a second connector (5) with one end connected to the second conductor (2) and the other end connected to another paired, inter-digital shaped electrode (3b), a conductive plate (6) disposed over the set of paired, inter-digital shaped electrodes such that when a user presses them, the set of paired inter-digital shaped electrodes is electrically connected to each other, and when a user releases them, they are electrically disconnected from each other, a protective layer (7) for protecting the paired, inter-digital shaped electrodes, the first and second conductors, the first and second connectors, and the conductive plate.

### BACKGROUND OF THE INVENTION

1. Field of the Invention

The present invention relates to a membrane switch and its application to acoustic strip wallpaper or picture board that generates sound. Particularly, the present invention is a thin-filmed membrane switch having a set of paired, inter-digital shaped terminals and insulation bump dots disposed underneath a printed picture or graphic on the strip wallpaper or picture board, for generating sounds when a user presses the membrane switch.

2. Description of the Prior Art

Membrane switches are widely used in various control panels of electronic devices. Generally, they consist of an upper double-sided adhesive tape, an upper layer, a tactile layer, a lower layer and a lower double-sided adhesive tape, as shown in FIG. 1. Such a membrane switch includes a tactile layer that causes the switch to close when a predetermined amount of pressure is applied thereon; otherwise, the switch remains open. In order to perform this function, the tactile layer is dome-shaped.

However, this shape is largely responsible for the overall thickness of the membrane switch. As a result, the thickness of an electronic device increases when a conventional membrane switch is used. Further, when it is used in very small electronic devices, the tactile layer cannot retain its original shape, due to lack of sufficient space, often resulting in faulty switching.

### SUMMARY OF THE INVENTION

An objective of the present invention is to provide a thin-filmed membrane switch that adopts a plurality of insulation bump dots to perform the function of the tactile layer of a conventional membrane switch. The thin-filmed membrane switch is comprised of: a first conductor (1) for electrically coupling a positive terminal of a power source, a second conductor (2) for electrically coupling a negative terminal of the power source, a set of paired, inter-digital shaped electrodes (3a, 3b) having a plurality of insulation bump dots (P) arranged in certain intervals, a first connector (4), with one end connected to the first conductor (1) and the other end connected to one of the paired, inter-digital shaped electrodes (3a), a second connector (5), with one end connected to the second conductor (2) and the other end connected to another paired, inter-digital shaped electrode (3b), a conductive plate (6) disposed over the set of paired, inter-digital shaped electrodes for maintaining a predetermined clearance when a user presses the set of paired, inter-digital shaped electrodes electrically connected to each other, and when a user releases same, electrically disconnect from each other, and a protective layer (7) for protecting the paired, inter-digital shaped electrodes, the first and second conductors, the first and second connectors, and the conductive plate.

Another objective of the present invention is to provide acoustic strip wallpaper that employs a membrane switch having insulation bump dots embedded underneath the graphic layer of printed pictures thereon. An acoustic strip wallpaper is comprised of: a graphic layer (11) with a plurality of images, pictures or figures on the surface, a plurality of membrane switches having a first conductor (1) for electrically coupling a positive terminal of a power battery (33), a second conductor (2) for electrically coupling a negative terminal of the power battery (33), a set of paired, inter-digital shaped electrodes (3a, 3b) having a plurality of insulation bump dots (P) arranged in certain intervals, a first connector (4) with one end connected to the first conductor (1) and the other end connected to one of the paired, inter-digital shaped electrodes (3a), a second connector (5) with one end connected to the second conductor (2) and the other end connected to another paired, inter-digital shaped electrode (3b), a conductive plate (6) disposed over the set of paired, inter-digital shaped electrodes such that when a user presses the set of paired, inter-digital shaped electrodes, they are electrically connected to each other, and when a user releases same, they are electrically disconnected from each other, a protective layer (7) for protecting the paired, inter-digital shaped electrodes, the first and second conductors, the first and second connectors and the conductive plate, and an audio device (30) for outputting sound information when a signal is transmitted from the membrane consisting of a plurality of acoustic micro-chips (31a, 31b), a speaker (32), and a power on-off switch (34).

The acoustic micro-chips (31a, 31b) are pre-stored sound information corresponding to the plurality of images on the graphic layer and the predetermined clearance is maintained by the insulation bump dots. A sponge layer (12) having a certain thickness is disposed between the graphic layer (11) and the membrane switches (SW), a moisture-proof layer (14) disposed underneath the sponge layer (12), and a connector (20) for coupling neighbored strips of wallpaper.

Yet another objective of the present invention is to provide a sound-generating picture board incorporating membrane switches having insulation bump dots embedded underneath the graphic layer of printed pictures thereon. An acoustic picture board, is comprised of: a case or frame (100) consisting of a front plate (110) with a plurality of circular openings (111), and a back plate (120), a picture board (200) with a plurality of paired pictures printed thereon, each of the paired pictures being identical or related in concept, a sound-producing means (300) for outputting sound information, the means consisting of a power source (310), a plurality of membrane switches (SW) that are closed only when a set of paired pictures, identical or related in concept, are pressed, a connector (340), a speaker (350) for outputting sound information associated with the pressed pictures and sound micro-chips (330) that is digitally stored, converting the associated sound information to analog, and transmitting same to the speaker (350) upon the closing of the paired membrane switches, wherein the plurality of membrane switches, consisting of a first conductor (1) for electrically coupling a positive terminal of a power battery (33), a second conductor (2) for electrically coupling a negative terminal of the power battery (33), a set of paired, inter-digital shaped electrodes (3a, 3b) having a plurality of insulation bump dots (P) arranged in certain intervals, a first connector (4) with one end connected to the first conductor (1) and the other end connected to one of the paired, inter-digital shaped electrode (3a), a second connector (5) with one end connected to the second conductor (2) and the other end connected to another paired, inter-digital shaped electrode (3b), a conductive plate (6) disposed over the set of paired, inter-digital shaped electrodes such that when a user presses the set of paired, inter-digital shaped electrodes, they are electrically connected to each other, and when a user releases same, they are electrically disconnected from each other, a protective layer (7) for protecting the paired, inter-digital shaped electrodes, the first and second conductors, the first and second connectors, and the conductive plate. Further, the picture frame has a slot (140) at one edge (130) for replacing with another picture board.

### BRIEF DESCRIPTIONS OF THE DRAWINGS

FIG. 1 is a schematic drawing illustrating a configuration of a conventional membrane switch.

FIG. 2 is a front view of membrane switch photograph, according to an implemental example of the present invention.

FIG. 3 is a rear view of membrane switch photograph, according to an implemental example of the present invention.

FIG. 4 illustrates a plurality of insulation bump dots disposed in the membrane switch, according to an implemental example of the present invention.

FIG. 5 is acoustic strip wallpaper installed on a wall, according to an implemental example of the present invention.

FIG. 6 is a block diagram of acoustic strip wallpaper, according to an implemental example of the present invention.

FIG. 7 is an outer feature of acoustic strip wallpaper installed on a wall, according to an implemental example of the present invention.

FIG. 8 is a sub-layer of acoustic strip wallpaper installed on a wall, according to an implemental example of the present invention.

FIG. 9 is a cross-section view of acoustic strip wallpaper installed on a wall, according to an implemental example of the present invention.

FIG. 10 is a plan view of an acoustic picture board with a membrane switch, according to an implemental example of the present invention.

FIG. 11 is a rear view of an acoustic picture board with a membrane switch, according to an implemental example of the present invention.

FIG. 12 is a block diagram of an acoustic picture board with a membrane switch, according to an implemental example of the present invention.

FIG. 13 is a schematic drawing of an acoustic picture board with a membrane switch, according to secondary implemental example of the present invention.

### DETAILED DESCRIPTION OF THE PREFERRED EMBODIMENT

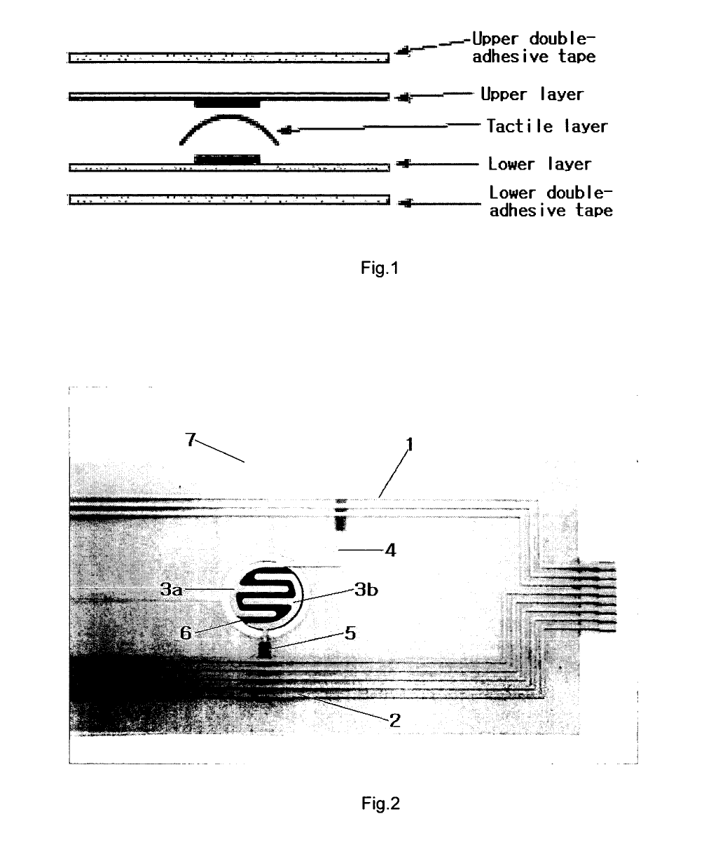

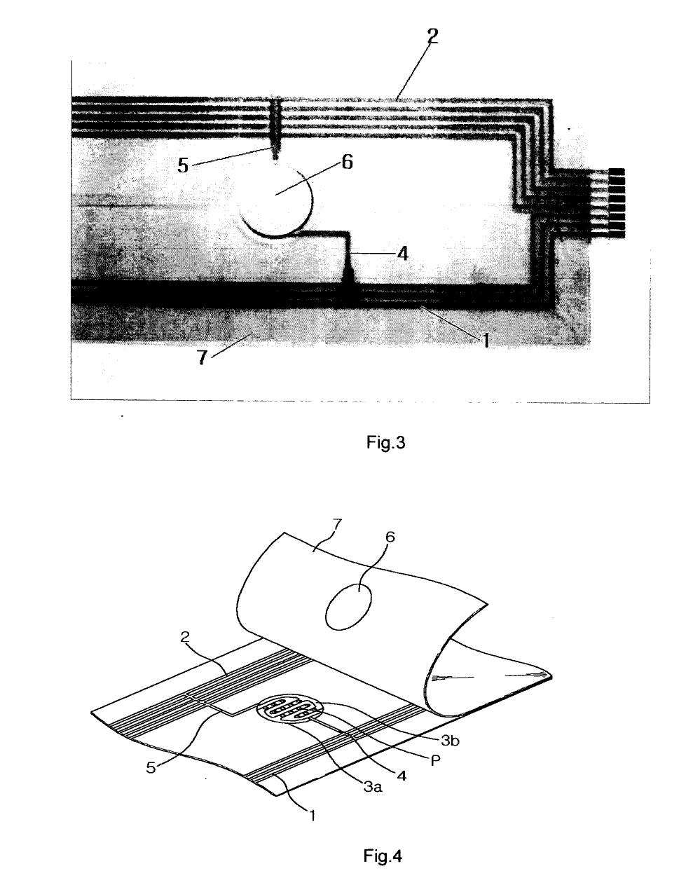

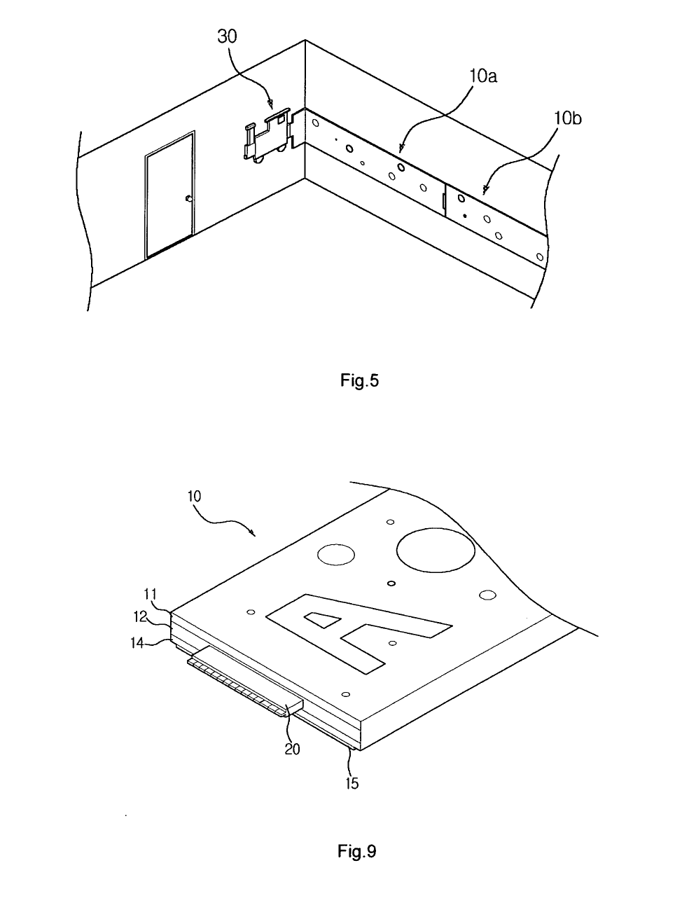

As shown in FIGS. 2 and 3, the membrane switch of the present invention comprises a first electrical conductor (1) connected to the positive terminal of a power source, a second electrical conductor (2) connected to the negative terminal of a power source, a set of paired, inter-digital shaped terminals (3a, 3b) having a plurality of insulation bump dots (P) arranged in constant intervals, a positive connecting line (4) for electrically connecting the first electrical conductor (1) and one end of the paired, inter-digital shaped terminal (3a), a negative connecting line (5) for electrically connecting the second electrical conductor (2) and the other end of the paired, inter-digital shaped terminal (3b). Specially, a plurality of insulation bump dots (P) is disposed between the conductive plates of the paired, inter-digital shaped terminals to provide clearance. Therefore, the paired, inter-digital shaped terminals (3a, 3b) are in electrically off states. When a user presses the membrane switch, the paired, inter-digital shaped terminals (3a, 3b) are electrically coupled. When the user releases the membrane switch, the paired, inter-digital shaped terminals (3a, 3b) are electrically decoupled. A protective shield (7) is laid over all of above elements.

Due to the application of insulation bump dots (P), the present membrane switch is much thinner than a conventional membrane switch that employs a dome-shaped tactile layer.

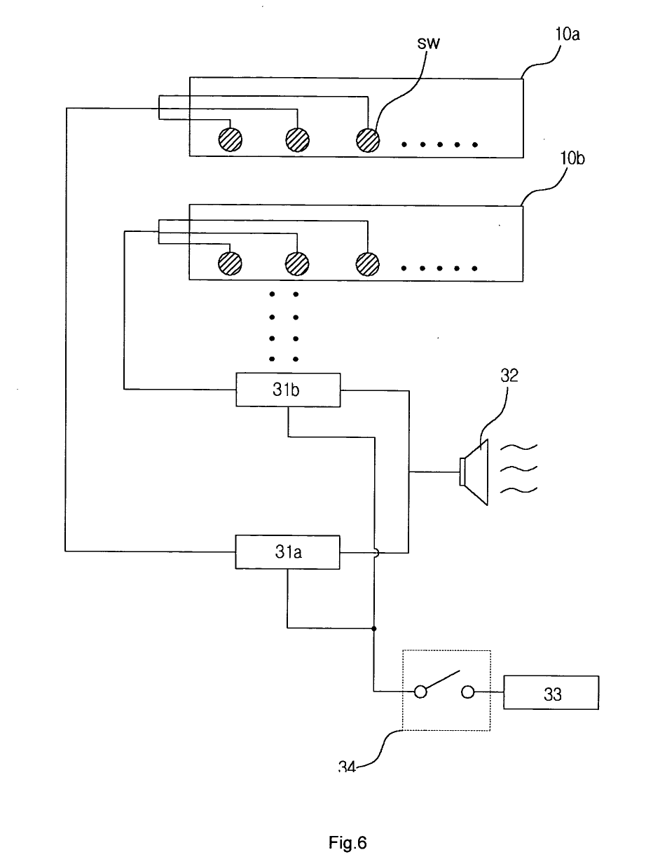

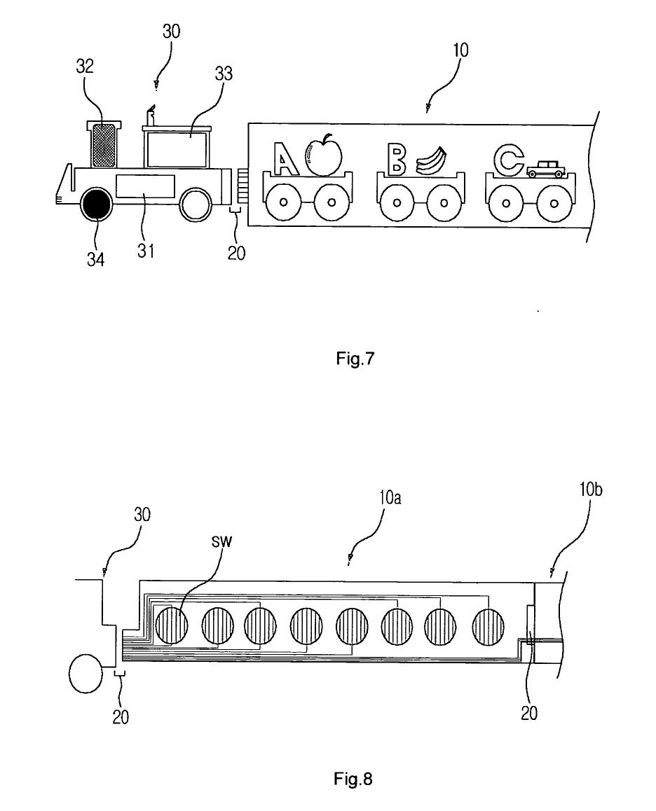

Referring to FIGS. 5 through 9, acoustic strip wallpaper is described according to an embodiment of the present invention: The sound-producing, strip wallpaper is comprised of a picture- or graphic-printed outer layer (11), a sponge layer (12) underneath the outer layer, a plurality of membrane switches (SW), a moisture- or water-proof layer (14), double-sided adhesive tape (15), a connecting unit (20) for connecting the neighbored acoustic strips of wallpaper, and an audio device (30) for outputting sounds when a user presses the membrane switches. Specifically, the strip wallpaper, formed relatively narrow and long, is applied along a certain height of the wall, horizontally, vertically or diagonally, for interior decoration. The outer layer (11) of the strip wallpaper is decorated with the various images or characters, such as numbers or letters, for attracting a user's interest or aesthetic feelings.

Underneath the graphical outer layer, a plurality of membrane switches (SW) is disposed. Each image or character printed on the outer surface of the strip wallpaper has a corresponding membrane switch (SW). Each membrane switch comprises a first electrical conductor (1), a second electrical conductor (2), and a set of paired, inter-digital shaped terminals (3a, 3b) with a plurality of insulation bump dots (P), a positive connecting line (4), a negative connecting line (5), a conductive plate (6) and a protective shield (7).

A sponge layer (12) having a certain thickness is installed between the outer layer (11) and the membrane switches (SW) for protecting the membrane switches (SW) from excessive pressure. In this implemental example of the present invention, a Urethane material is used for the sponge layer (12). However, the present invention is not limited to a specific material for the sponge layer.

A moisture- or water-proof layer (14) is disposed underneath the sponge layer (12) and the membrane switches (SW) for protecting the membrane switches from moisture. A water-resistant material, such as plastic or vinyl, is used for the waterproof layer (14).

Double-sided adhesive tape (15) is attached underneath the moisture- or water-proof layer (14) for adhering the acoustic strip wallpaper on the wall.

As seen at a cross-section, the acoustic strip wallpaper forms a plug-type connector (20) at one end and a receptacle-type connector at the other end for connecting neighbored strips of wallpaper in series. Therefore, sound is output through an outputting device when a user presses any one of the membrane switches in the series of wallpaper strips. Accordingly, it is possible to use multiple wallpaper strips in series by connecting strips to each other on a wall.

An audio device (30) equipped with a receptacle-type connector is connected to a plug-type connector (20) of the acoustic strip wallpaper for producing sound when a user presses the membrane switches. The audio device (30) comprises a plurality of acoustic micro-chips (31a, 31b), a speaker (32), a battery (33), and a power on-off switch (34).

The acoustic micro-chips (31a, 31b) have the functions of storing and performing the sound information corresponding to the printed image information on the wall. A battery (33) is used as a power source. A power on-off switch is selectively operated depending on a user's demand. Therefore, it is possible to use as many strips of wallpaper as needed by connecting them in series on a wall.

Hereinafter, the operation of the strip wallpaper is described as follows: a user switches on the power switch (34), then presses the membrane switch of a selected picture on the strip wallpaper. As the user presses the membrane switch, the conductive plates (6) of the paired, inter-digital shaped terminals (3a, 3b) are bent down to contact each other. An electrical signal is transmitted to the acoustic micro-chips (31a, 31b) to generate a sound through the audio device (30).

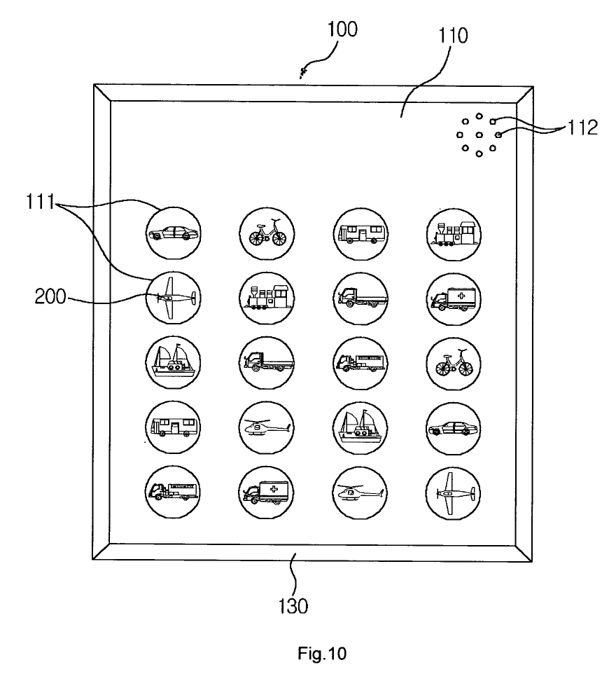

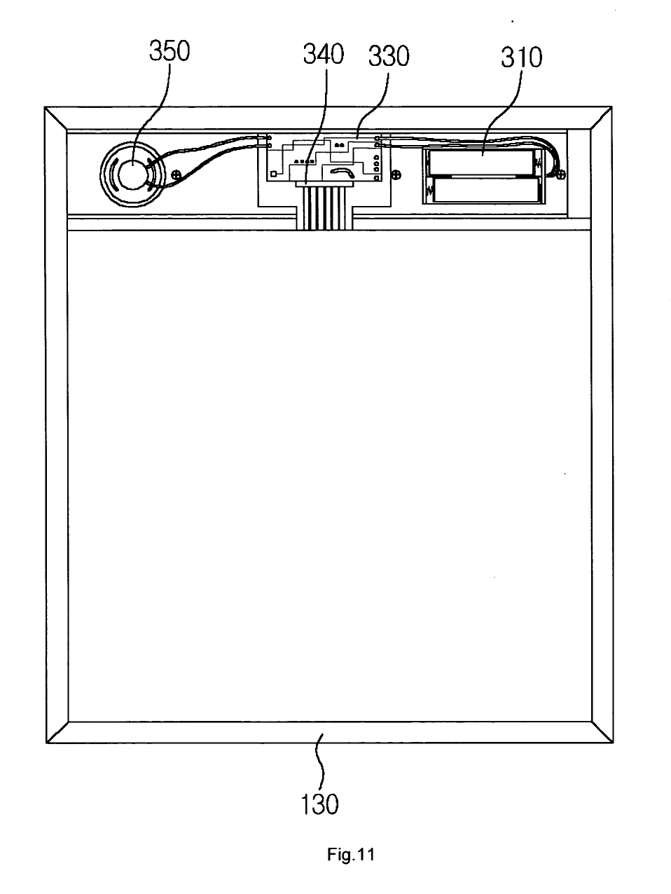

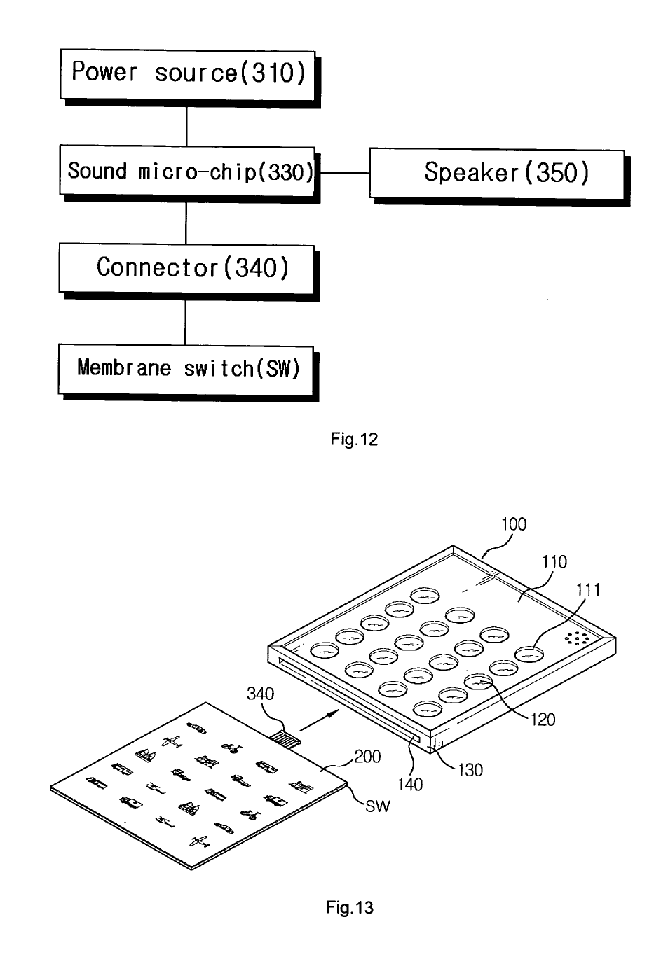

Now, referring to FIGS. 10 through 13, an acoustic picture board equipped with the membrane switches, according to another embodiment of the present invention, is described as follows. The acoustic picture board comprises a picture case or frame (100) made of wood, a front picture board (200) with a plurality of circular openings (111), and an audio device (300) to output the sound information. The various pictures with paired meanings or concepts are scattered and displayed in the circular openings (111). Then, a user presses the pictures directly through the recesses or uses puzzles to push the pictures. At the upper left corner of the board, there is a plurality of smaller holes (112) formed for outputting the sound generated by the speaker. On the rear of the picture board, a switch (SW), a power source, and an audio device (300) are supportably attached.

The implemental example of the present invention has twenty circular openings with a diameter of 4 cm. However, the number of openings, the shape and the size are not limited to those described. The picture frame and the front board are made of wood, with an identical number of pictures, and are sized to be inserted into the frame or to replace the picture board.

The picture board (200), having printed images or meanings, is detachably inserted between the front plate (110) and the back plate (120) of the frame (100). Each of the paired pictures is displayed in a paired meaning or concept, such as the relationship of the sea to a ship, of a road to a car, or of the sky to an airplane. The sound-producing means (300) comprises a power source (310), membrane switches (SW), a sound micro-chip (330), a connector (340), and a speaker (350). The power source (310) is preferably a DC battery, but is not limited to a DC battery.

The membrane switches (SW) are disposed between the picture board (200) and the back plate (120). The membrane switches corresponding to the paired pictures are designed to close only when the paired pictures are simultaneously pressed. The sound micro-chips (330) are digitally stored sound information associated with the pictures. When the paired membrane switches are closed, the digital sound information is converted to analog for outputting through the speaker.

Each membrane switch is comprised of a first electrical conductor (1), a second electrical conductor (2), a set of paired, inter-digital shaped terminals (3a, 3b) with a plurality of insulation bump dots (P), a positive connecting line (4), a negative connecting line (5), a conductive plate (6), and a protective shield (7). The sound micro-chip (330) of the present invention stores not only Korean words with pronunciation, but also English words with pronunciation. It is also possible to store any other languages with pronunciation.

The connector (340) has the function of connecting the switches (SW) and the sound micro-chips (330), so that one end is connected to the switches (SW) and the other end is detachably coupled to the sound micro-chips (330). The speaker (350) is for outputting the sound information.

Hereinafter, the operation of the picture board of the present invention is described. The picture board is designed to output sound information only when a user simultaneously presses the identically paired pictures. For example, when the user presses only one of the paired car images on the first row without pressing the other paired car image on the fourth row, the pressed switch is closed, but the paired switch corresponding to the car image on the fourth row is not closed. As a result, the sound information associated with the car is not outputted. Likewise, unless the user presses the identically paired images on the board at the same time, the sound information associated with the corresponding images is not generated because the switches, as a whole, are open. On the other hand, if both paired images are simultaneously pushed, directly or using puzzles, the membrane switches corresponding to the images are closed, and the sound information associated with the images stored in the sound micro-chip is converted to analog and generated through the speaker.

Referring to FIG. 13, an acoustic picture board (200) according to another implemental example of the present invention is described. The acoustic picture board comprises a picture case or frame (100) made of wood, a front picture board (200), and an audio device (300) to output the sound information. The front picture board (200) has a plurality of circular openings (111), a plurality of tiny speaker holes (112) at the upper left corner, and a slot (140) at one edge (130) of the frame. A picture board (200) may be inserted through the slot between the front plate (110) and the back panel (120) of the case (100). Therefore, it is possible to replace the picture board with another picture, as the user desires. A connector (340) is detachably coupled to the audio device (300). Thus, the connector (340) of any new picture board can be electrically coupled to the audio device (300), enabling the audio device (300) to output the sound information associated with the replaced picture board. According to the second implemental example of the present invention, the picture board and the membrane switches were described as being inserted separately through the slot. However, the inserting method of the present invention is not limited as described. The picture board and switches could be integrated by using adhesives, and this integrated embodiment could be inserted through the slot. The operation of the second embodiment is not described, as it is the same manner as that of the first embodiment.

According to the present invention, the conductive, paired, inter-digital shaped terminal of the thin-filmed membrane switch is electrically separated from each other by insulation bump dots. This thin-filmed membrane switch is thinner than a conventional membrane switch which adopts a tactile layer, and therefore provides less mal-operation.

It is possible to provide an acoustic strip wallpaper applied with this thin-filmed membrane switch.

It is also possible to provide an acoustic picture board applied with this thin-filmed membrane switch, without fault operation.

While the present invention has been described in detail with its preferred embodiments, it will be understood that [it] further modifications are possible. The present application is therefore intended to cover any variations, uses or adaptations of the invention, following the general principles thereof, and includes such departures from the present disclosure as come within known or customary practice in the art to which this invention pertains, within the limits of the appended claims.

What is claimed is:

1. A thin-filmed membrane switch, comprising:
a first conductor (1) for electrically coupling a positive terminal of a power source,
a second conductor (2) for electrically coupling a negative terminal of said power source,
a set of paired, inter-digital shaped electrodes (3a, 3b) having a plurality of insulation bump dots (P) arranged in certain intervals,
a first connector (4), with one end connected to the first conductor (1) and the other end connected to one of the paired, inter-digital shaped electrodes (3a),
a second connector (5), with one end connected to the second conductor (2) and the other end connected to another paired, inter-digital shaped electrode (3b),
a conductive plate (6) disposed over the set of paired, inter-digital shaped electrodes for maintaining a predetermined clearance when a user presses the set of paired, inter-digital shaped electrodes electrically connected to each other, and when a user releases same, electrically disconnect from each other, and
a protective layer (7) for protecting said paired, inter-digital shaped electrodes, said first and second conductors, said first and second connectors, and said conductive plate.

2. An acoustic strip wallpaper, comprising:
a graphic layer (11) with a plurality of images, pictures or figures on the surface,
a plurality of membrane switches having a first conductor (1) for electrically coupling a positive terminal of a power battery (33), a second conductor (2) for electrically coupling a negative terminal of said power battery (33), a set of paired, inter-digital shaped electrodes (3a, 3b) having a plurality of insulation bump dots (P) arranged in certain intervals, a first connector (4) with one end connected to the first conductor (1) and the other end connected to one of the paired, inter-digital shaped electrodes (3a), a second connector (5) with one end connected to the second conductor (2) and the other end connected to another paired, inter-digital shaped electrode (3b), a conductive plate (6) disposed over the set of paired, inter-digital shaped electrodes such that when a user presses the set of paired, inter-digital shaped electrodes, they are electrically connected to each other, and when a user releases same, they are electrically disconnected from each other, a protective layer (7) for protecting said paired, inter-digital shaped electrodes, said first and second conductors, said first and second connectors and said conductive plate, and
an audio device (30) for outputting sound information when a signal is transmitted from said membrane consisting of a plurality of acoustic micro-chips (31a, 31b), a speaker (32), and a power on-off switch (34).

3. An acoustic strip wallpaper as claimed in claim 2, wherein said acoustic micro-chips (31a, 31b) are pre-stored sound information corresponding to the plurality of images on the graphic layer and said predetermined clearance is maintained by the insulation bump dots.

4. An acoustic strip wallpaper as claimed in claim 2 further comprises a sponge layer (12) having a certain thickness disposed between said graphic layer (11) and said membrane switches (SW), a moisture-proof layer (14) disposed underneath said sponge layer (12), and a connector (20) for coupling neighbored strips of wallpaper.

5. An acoustic picture board, comprising:
a case or frame (100) consisting of a front plate (110) with a plurality of circular openings (111), and a back plate (120),
a picture board (200) with a plurality of paired pictures printed thereon, each of said paired pictures being identical or related in concept,
a sound-producing means (300) for outputting sound information, said means consisting of a power source (310), a plurality of membrane switches (SW) that are closed only when a set of paired pictures, identical or related in concept, are pressed, a connector (340), a speaker (350) for outputting sound information associated with the pressed pictures and sound micro-chips (330) that is digitally stored, converting the associated sound information to analog, and transmitting same to the speaker (350) upon the closing of the paired membrane switches,
wherein said plurality of membrane switches, consisting of a first conductor (1) for electrically coupling a positive terminal of a power battery (33), a second conductor (2) for electrically coupling a negative terminal of said power battery (33), a set of paired, inter-digital shaped electrodes (3a, 3b) having a plurality of insulation bump dots (P) arranged in certain intervals, a first connector (4) with one end connected to the first conductor (1) and the other end connected to one of the paired, inter-digital shaped electrode (3a), a second connector (5) with one end connected to the second conductor (2) and the other end connected to another paired, inter-digital shaped electrode (3b), a conductive plate (6) disposed over the set of paired, inter-digital shaped electrodes such that when a user presses the set of paired, inter-digital shaped electrodes, they are electrically connected to each other, and when a user releases same, they are electrically disconnected from each other, a protective layer (7) for protecting said paired, inter-digital shaped electrodes, said first and second conductors, said first and second connectors, and said conductive plate.

6. An acoustic picture board as claimed in claim 5 is further comprised of a picture frame have a slot (140) at one edge (130) for replacing with another picture board.
